(19) United States
(12) Patent Application Publication
(10) Pub. No.: US 2025/0100054 A1
(43) Pub. Date: Mar. 27, 2025

(54) ADAPTIVE DRILLING SYSTEM

(71) Applicant: Shane L. Combs, West Richland, WA (US)

(72) Inventor: Shane L. Combs, West Richland, WA (US)

(21) Appl. No.: 18/776,275

(22) Filed: Jul. 18, 2024

Related U.S. Application Data
(60) Provisional application No. 63/584,737, filed on Sep. 22, 2023.

(51) Int. Cl. B23B 47/28; B23B 39/10; G21C 19/26

(52) U.S. Cl. CPC B23B 47/28; B23B 39/10; G21C 19/26

(57) ABSTRACT

An adaptive drilling device for extracting bolts from a control rod drive mechanism (CRDM) in a boiling water nuclear reactor includes a guide assembly configured to align and secure drilling activity, a drill assembly configured to drive a drill bit into a CRDM bolt, and a thrust assembly configured to linearly and bidirectionally drive the drill assembly. The guide assembly has three guide plates and a pair of guide rods. The drill assembly includes a gear reduction drive motor, drill bearings, a drill bit, and a securing subassembly configured to secure the drill assembly to a first guide plate. The thrust assembly includes a thrust handle connected to the drive motor, a central plate nut, a lead screw running through the central plate nut and connected to the thrust handle, and a feed wheel connected to the lead screw.

### FIELD OF THE INVENTION

This disclosure relates to the field of nuclear facility systems and devices, including their operative safety and maintenance.

### BACKGROUND

In a boiling water nuclear reactor, or BWR, there are eight high-strength alloy socket head cap screws (bolts) that retain Control Rod Drives (CRDs) by means of a seal flange and ring flange located on the underside of the pressure vessel of the reactor. The CRDs are the drive mechanism that inserts and retracts the Boron control rods. The control rods act as a moderator or throttle that slows the fission process between the fuel bundles of a nuclear reactor. These CRDs require maintenance to ensure that this throttling action remains reliable. By way of example, a Boiling Water Nuclear Reactor may have 185 CRDs, such as those made by GE and Hitachi. It is common practice that nuclear facilities undergo routine maintenance (pursuant to their operating licenses, state and federal licenses and guidelines etc.) wherein at least 10% of the CRDs (e.g. 19 CRD units) must be serviced per each refuel outage. In some cases, this routine maintenance occurs every 2 years. Much of the planned maintenance on nuclear reactors occurs during refuel outages because much of the plant is inaccessible during full power operations due to elevated radiation dose rates (i.e. “dose”), heat, and other hazards. Dose rates are tracked on anyone exposed to radiation, and are a key consideration in any repair solution. The goal is to keep this exposure (dose rate) to a minimum. Anything that reduces exposure is highly desired in the nuclear industry. The less time spent in a high dose area doing work, the better. Similar to an X-Ray technician, exposure limits are regulated by Federal guidelines that allow a certain dose per year for a worker in a nuclear facility. Although maintenance and repairs are performed during refuel outages, time is of the essence in scheduling and performing the work, including accounting for unforeseen and emergent issues that may arise.

During removal of the bolting on a given CRD, one or more of the bolts may become unremovable, most likely due to a galled thread formed as a result of the bolt/flange interface being stainless steel on stainless steel. This problem can also be discovered in the context of reactor pressure vessel (RPV) leakage testing (i.e. hydrodynamic testing, or “hydro”) in which the pressure vessel is tested prior to reactor startup. The bolt would need to be drilled out to the tap drill size, the head of the bolt removed, and the CRD extracted and then re-threaded. Contractors report that stuck bolts are an industry wide problem in this context. Related services typically encompass removal of the seal rings, inspection of seal ring surfaces, and replacement of seals and reinstallation. If unrepairable, an engineered thread insert, or other repair method would need to be sought. Since the extent of damage to the threaded area of the bottom mounting surface of the vessel is not yet established, it is critical to maintain the existing hole center and angle in order to repair the damaged thread while minimizing the amount of repair to avoid compromising vessel integrity.

Conventional solutions to this problem involve improvised processes and machines that are risky, heavy, cumbersome, and dangerous in an already less than ideal work environment. Under vessel work comes with a high (radiation) dose, in an uncomfortable confined space, and work is done wearing powered air-purifying respirators (PAPRs). The configuration and contamination risk makes it difficult to get some traditional tools into the area. Thus, extraction times are long, involve a high dose, and are costly. In some instances, a stuck bolt can result in $250,000 of labor and material costs, 3 to 5 days of work, and an excessive dose (e.g. 3.8 man/rem dose expended over 3 days). The industry standard roentgen equivalent man (rem) is a CGS (Columbia Generating Station) unit of equivalent dose, effective dose, and committed dose, which are dose measures used to estimate potential health effects of low levels of ionizing radiation on the human body. Quantities measured in rem are designed to represent the stochastic biological risk of ionizing radiation, which is primarily radiation-induced cancer.

### SUMMARY

An adaptive drilling device for extracting bolts from a control rod drive mechanism (CRDM) in a boiling water nuclear reactor includes a guide assembly configured to align and secure drilling activity, a drill assembly configured to drive a drill bit into a CRDM bolt, and a thrust assembly configured to linearly and bidirectionally drive the drill assembly. The guide assembly has three guide plates and a pair of guide rods. The drill assembly includes a gear reduction drive motor, drill bearings, a drill bit, and a securing subassembly configured to secure the drill assembly to a first guide plate. The thrust assembly includes a thrust handle connected to the drive motor, a central plate nut, a lead screw running through the central plate nut and connected to the thrust handle, and a feed wheel connected to the lead screw.

### BRIEF DESCRIPTION OF THE DRAWINGS

FIG. 1 illustrates a front perspective view of an adaptive drilling device in an inverted position relative to an operational configuration in accordance with an embodiment of the present disclosure.

FIG. 2 illustrates a front perspective view of an exploded guide assembly in a normal orientation relative to an operational configuration in accordance with an embodiment of the present disclosure.

FIGS. 3A-C illustrate bottom views of guide plates in accordance with an embodiment of the present disclosure.

FIG. 4 illustrates a front perspective view of an exploded drill assembly and an exploded thrust assembly in a normal orientation relative to an operational configuration in accordance with an embodiment of the present disclosure.

FIG. 5 illustrates a back perspective view of an adaptive drilling device in a normal position relative to an operational configuration and being installed onto a simplified CRD mechanism in accordance with an embodiment of the present disclosure.

FIG. 6 illustrates a back perspective view of an adaptive drilling device installed onto a simplified CRD mechanism and in an operational configuration in accordance with an embodiment of the present disclosure.

FIG. 7 illustrates a back perspective view of an adaptive drilling device augmented by accessories including a barrel attachment, a support bar assembly, and a foot control pedal in accordance with an embodiment of the present disclosure.

FIG. 8 illustrates a perspective view of an adaptive drilling device in a normal position relative to an operational configuration and being installed onto a simplified CRD mechanism using adapter nuts in accordance with an embodiment of the present disclosure.

FIG. 9 illustrates a flowchart outlining a series of steps taken in order to install an adaptive drilling device into an operational configuration in accordance with an embodiment of the present disclosure.

FIG. 10 illustrates a flowchart outlining a series of steps taken in order to perform drilling procedures using an adaptive drilling device installed in an operational configuration in accordance with an embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The present invention provides a device and methods designed to address problems with a CRD mechanism (CRDM) located on the underside of a pressure vessel found in a boiling water nuclear reactor (BWR) in a safer, more efficient, and more cost-effective manner. During routine maintenance or hydro procedures, one or more main flange bolts securing a main seal flange of a CRDM can get stuck, the associated flange may leak, and nuclear plant workers may be unable to extract one or more main flange bolts. The present invention provides an adaptive drilling device designed to address such problems with an under-vessel CRDM in a safer, more efficient, and more cost-effective manner.

The device and methods of the present invention were tested in a mock-up work area replicating an actual under-vessel configuration, on the bottom of a nuclear reactor. Typically, CRDMs and associated instrumentation wiring are spaced about 16 inches apart from each other. This working environment presents 185 m/rem per hour dose rates, with 15-minute work stay times per jump. Typically, there is an approximately 90-110° F. ambient temperature in the work area. Technicians wear triple protective jumpsuits having powered air-purifying respirators (PAPRs). Dose rates are tracked on anyone exposed to radiation. Radiation exposure must be kept to a minimum, per industry guidelines. Anything that cuts exposure is highly desired in the Nuclear Industry. The less time spent working in a high dose area, the better. There are federal limits for how much dose-per-year a worker is allowed, similar to the limits for X-Ray technicians. Overall, the present invention allows work (drilling out a stuck bolt) to be done faster and more efficiently, thus reducing time in a high dose area and mitigating the accumulated dose.

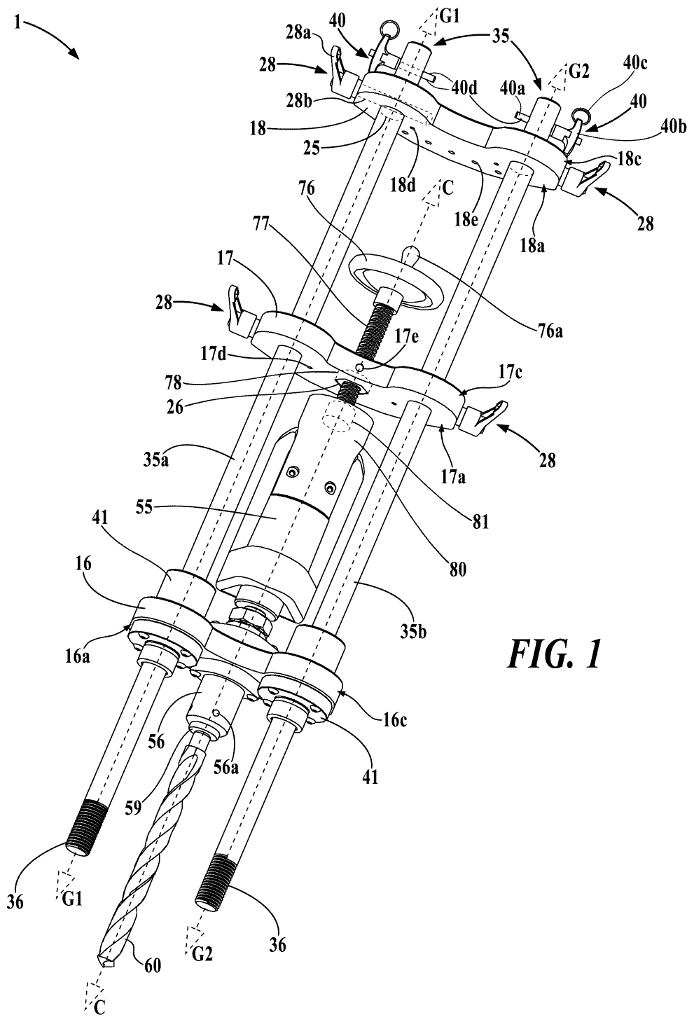

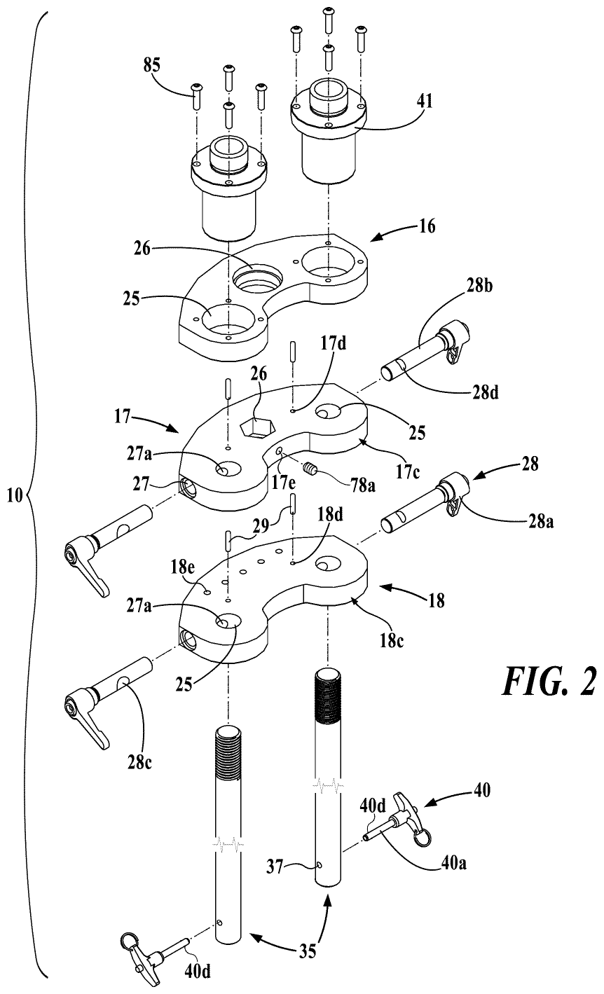

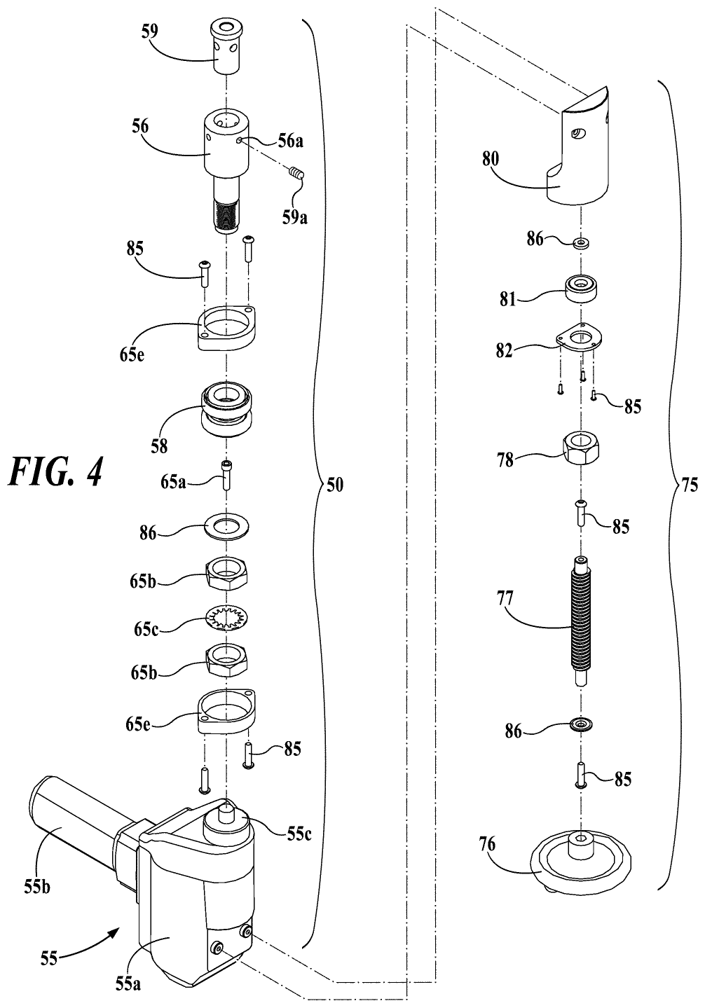

An exemplary adaptive drilling device of the present invention is a custom drilling machine that attaches to a bolt pattern, providing a solid, accurate means to drill out, or extract, and rethread an affected fastener. Using the present device for BWR repair work reduces time in a high dose area, therefore mitigating the accumulated dose. Referring to FIG. 1, an adaptive drilling device 1 (shown in an inverted position, relative to an operational configuration wherein the device has been installed) comprises a guide assembly (see exploded guide assembly 10 of FIG. 2) that generally aligns and secures drilling activity, a spindle or drill assembly (see exploded drill assembly 50 of FIG. 4) that drives a drill bit into a bolt (e.g. a CRDM bolt), and a ball screw feed mechanism or thrust assembly (see exploded thrust assembly 75 of FIG. 4) that linearly and bidirectionally drives the drill assembly.

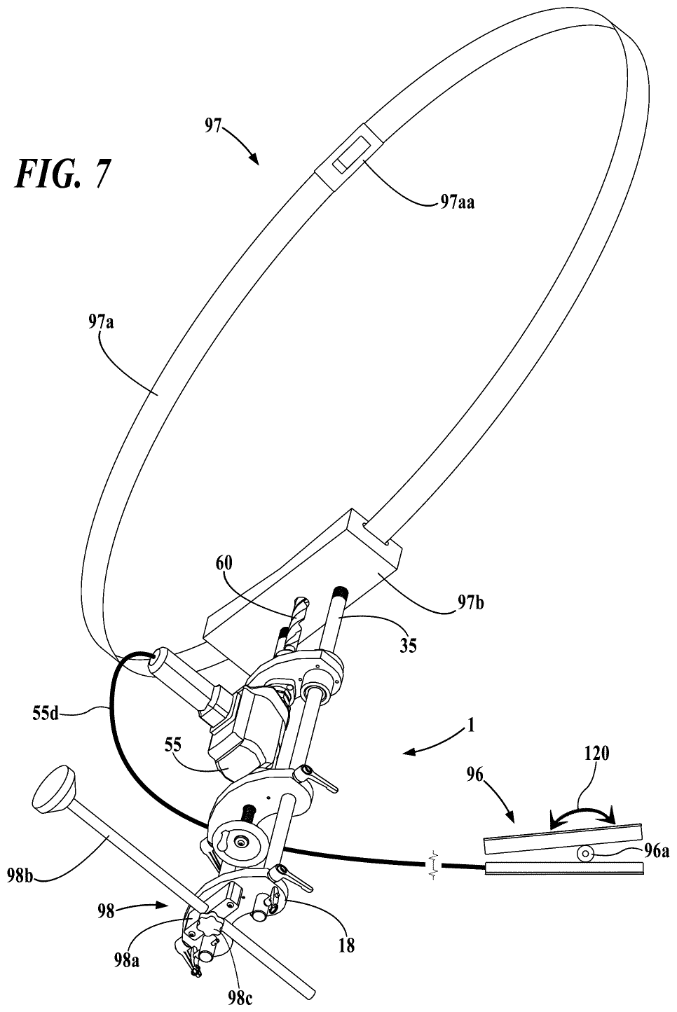

An exemplary guide assembly comprises three guide plates, including a top spindle plate, or first plate 16, a middle feed (or drive) plate, or second plate 17, and a bottom stabilizer plate, or third plate 18. The guide plates are positioned along a central height axis C running through the adaptive drilling device 1. Each guide plate comprises a top surface and an opposing bottom surface, as well as an edge surface. As seen in FIG. 1, the spindle plate 16 includes top surface 16a and edge surface 16c. The feed plate 17 includes top surface 17a and edge surface 17c. The stabilizer plate 18 includes top surface 18a and edge surface 18c. Each exemplary guide plate further comprises a pair of guide holes 25 (see the labeled example shown in FIG. 1 with dashed lines to help differentiate it from a guide rod 35a) disposed symmetrically relative to the central height axis C. Considering all three guide plates as a group, a first set of three guide holes 25 are axially aligned along a first guide hole axis G1, while a second set of the three remaining guide holes 25 are axially aligned along a second guide hole axis G2. Both guide hole axis G1 and guide hole axis G2 run parallel to the central height axis C. The bottom stabilizer plate 18 further comprises a pair of roll pin receiving holes 18d, these small holes symmetrically disposed relative to the central height axis C. As well, the stabilizer plate 18 further comprises a linearly aligned set of five small threaded anchoring holes 18e, which can receive anchoring accessories (see support bar assembly 98 of FIG. 7 for an example of such anchoring usage). Similarly to the stabilizer plate 18, the feed plate 17 further comprises a pair of roll pin receiving holes 17d having the same purpose as those holes 18d found in the stabilizer plate 18. Additionally, the edge surface 17c of the feed plate 17 comprises a threaded central edge hole 17e running through the body of the plate in a direction orthogonal to the edge surface and central height axis C. This central edge hole 17e receives a set screw (see set screw 78a of FIG. 2) which locks the position of an Acme hex nut 78 (see thrust assembly description below).

An exemplary guide assembly further comprises a pair of linear guides, or guide rods 35, each rod having a length and a diameter, the guide rods 35 being parallel to each other while running centrally through the guide holes 25 along the rod lengths. A first guide rod 35a runs through the first set of three guide holes, that set axially aligned along guide hole axis G1, while a second guide rod 35b runs through the second set of three guide holes, that set axially aligned along guide hole axis G2. The guide plates are slidably engaged with the guide rods 35. The spindle plate 16 has an attached pair of linear bearings 41 configured to facilitate linear plate motion along the guide rods 35 which run through the bearings 41, the bearings further providing support for axial movement as well. The second/feed plate 17 and third/stabilizer plate 18 each have a lockable position along the guide rods 35. Each of these locking plates includes a pair of sliding locks 28 entering through the edge surface of the plate and running through the body of the plate. Each pair of sliding locks 28 can lock and unlock its respective plate's position along the guide rods 35. Each sliding lock 28 further comprises a rotatable handle 28a and a shaft 28b (shown with dashed lines as it is here hidden within the body of the guide plate), the shaft being the portion of the lock 28 that interfaces with the body of the guide plate. Each guide rod 35 comprises a threaded end 36, these threaded ends projecting away from the first guide plate's top surface 16a. Each guide rod 35 further comprises a cross-drilled pass-through hole, or pin pass-through (see pin pass-through 37 of FIG. 2) on that end of the guide rod 35 opposing the threaded end. Each pin pass-through runs fully through the diameter of the guide rod 35 and slidably receives a detent pin 40, the received detent pins providing a stop to prevent the sliding of guide plates and associated assemblies beyond the length of the guide rods 35. Each detent pin 40 further comprises a T-handle 40b with a ring 40c, and a pin portion 40a with a ball detent 40d, the pin portion (partially shown with dashed lines as that portion runs through the guide rod 35a) being received by the pass-through hole in the guide rod 35.

An exemplary drill assembly comprises a variable speed, gear reduction drive motor, or drill 55, a drive shaft 56 with shaft opening 56a, a bushing 59 nested within the drive shaft 56, and a drill bit 60 secured within the bushing 59. The drill bit 60 has a length, and is rotatably driven by the drive motor 55. The drill bit 60 is axially aligned with the central height axis C along its bit length. The drill assembly further comprises a securing subassembly (see securing subassembly components of FIG. 4) which secures the drill assembly to the spindle plate 16.

An exemplary thrust assembly comprises an offset coupler, or thrust handle 80 connected to the drive motor 55, an Acme hex central plate nut 78 (see the labeled example shown in FIG. 1 with dashed lines to help differentiate it from a central hole 26, the central plate nut 78 here being mostly hidden and partially visible at its bottom surface), an Acme thread form lead screw 77 running through the central plate nut 78 and connected to the thrust handle 80, and a hand feed wheel 76 connected to the lead screw 77. The feed wheel 76 can be rotated to provide thrust, driving the drill assembly and spindle plate 16 along the central height axis C.

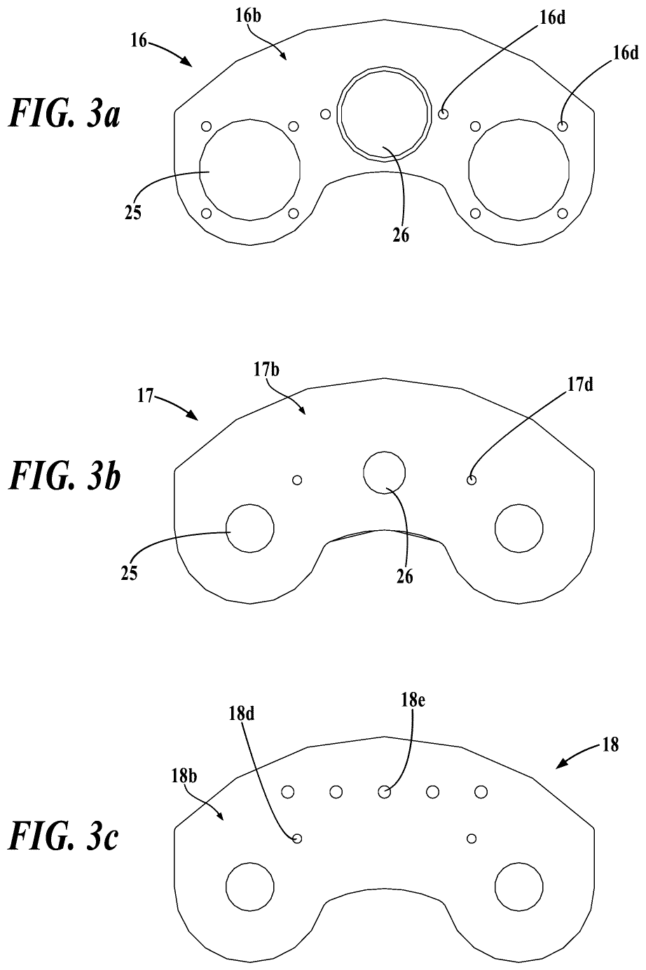

An exemplary drive motor 55 is positioned between the spindle plate 16 and feed plate 17. The long drill bit 60 runs centrally through the spindle plate's central hole (see central hole 26 and spindle/first plate 16 of FIG. 3A) and projects away from the top surface 16a of the spindle plate 16, similarly to the threaded ends 36 of the guide rods 35. The relative positions of the spindle mechanism (i.e. the position of the drill bit 60) and linear guides 35 form an arrangement pattern, the adaptive drilling device 1 thus providing adaptive integration with a plurality of bolted structures via this arrangement pattern in order to facilitate drilling activity. The thrust handle 80 is positioned between the spindle plate 16 and feed plate 17, the thrust handle further comprising a thrust bearing 81 (shown with dashed lines, as it is here hidden within the thrust handle). The central plate nut 78 is nested within the feed plate's central hole 26, the lead screw 77 running through the thrust bearing 81 and central plate nut 78, the lead screw 77 further projecting past both the top and bottom surfaces of the feed plate 17. The hand feed wheel 76 is positioned between the feed plate 17 and stabilizer plate 18, an exemplary feed wheel comprising a knob 76a protruding from the wheel, the knob being manipulatable by a user to rotate the wheel.

Referring to FIG. 2, a front perspective view shows an exploded guide assembly 10 in a normal orientation relative to an operational configuration of the adaptive drilling device. The feed plate 17 and stabilizer plate 18 each further comprise a pair of lock-receiving edge holes 27 in edge surface 17c and edge surface 18c, respectively. Each pair of edge holes 27 is disposed symmetrically relative to the central height axis C, each edge hole 27 slidably receiving a lock 28. Additionally, central edge hole 17e is shown with exploded set screw 78a, this set screw locking the position of the acme hex nut 78. Now considering the feed plate 17 and spindle plate 16, the differing exemplary shapes of each central plate hole 26 illustrate both structural and functional variations of this feature. The central plate hole 26 of the spindle plate 16 is circular and larger, indicating the size and shape of components found in the spindle assembly (or spindle mechanism, when considering a subset of the assembly dedicated to activities executed by a typical spindle), these components passing through this central plate hole. The central plate hole 26 of the feed plate 17 is angular with six sides, smaller than that of the spindle plate 16, indicating features of the acme hex nut 78 nested within this central plate hole. Moreover, the spindle plate 16 has larger guide holes 25 than the other two guide plates, in order to accommodate the size of the inserted linear bearings 41, these bearings attached to the spindle plate via securing screws 85.

The stabilizer plate 18 is depicted with threaded anchoring holes 18e, which run fully through the plate's height. Both the feed plate 17 and stabilizer plate 18 each further comprise the aforementioned pair of receiving holes 17d and holes 18d, respectively, running fully through the plate height, these receiving holes being smaller in size than the guide holes 25, each receiving a roll pin 29. Each exemplary guide hole 25 of the feed plate 17 and stabilizer plate 18 further includes a curved inner contact opening 27a within the guide hole 25 and orthogonally positioned relative to the guide hole's top and bottom surface openings (see bottom surfaces 17b and 18b of FIGS. 3B & 3C, respectively). Each sliding lock 28 further comprises a rotatable handle 28a and a shaft 28b, the shaft comprising both a rod notch 28c and a pin notch 28d, these notches diametrically opposing each other on the shaft. The shaft 28b is the slidable portion received by the guide plate's edge holes 27, each edge hole being positioned with a proximate guide hole 25 and guide rod 35, as well as a proximate roll pin receiving hole. Rotation of the sliding lock handles 28a provides locked or unlocked plate positions. In one example, each rod notch 28c slidably contacts its proximate guide rod 35 through the curved inner contact opening 27a in an unlocked plate configuration, while each pin notch 28d slidably contacts its proximate roll pin 29. The rod and pin notches lose the above slidable contact in a locked plate configuration, such that un-notched portions of the lock shafts 28b contact the guide rods 35 and roll pins 29.

The pair of quick-release detent pins 40 are slidably receivable by the linear guides 35 through their cross-drilled holes 37, with one detent pin received per linear guide. Each detent pin 40 comprises pin portion 40a with ball detent 40d, the pin portion running through the pin pass-throughs 37. The received detent pins 40 provide a stop to prevent the sliding of guide plates and associated assemblies and mechanisms beyond the linear guides 35. The pin pass-throughs 37 can further receive standard steel rods, the inserted steel rods manipulatable to substantially tighten the installed linear guides 35 into a more secure operational configuration.

Referring to FIGS. 3A-C, bottom views of the guide plates are depicted. The spindle plate 16 includes a bottom surface 16b, just as the feed plate 17 includes a bottom surface 17b, and the stabilizer plate 18 includes a bottom surface 18b. An exemplary spindle plate 16 is depicted with screw holes 16d, these receiving securing screws 85 to connect the linear bearings 41. Feed plate 17 is shown with roll pin receiving holes 17d, just as stabilizer plate 18 is shown with roll pin receiving holes 18d. Moreover, stabilizer plate 18 includes the regularly spaced, linearly aligned set of five threaded anchoring holes 18e, these holes being slightly larger than the roll pin receiving holes 18d. Each guide plate's top and bottom surfaces run parallel to each other and orthogonally to the central height axis C, the edge surface running continuously between the top and bottom surfaces and orthogonally relative to said surfaces. Each edge surface defines the height of the guide plate, the first/spindle plate 16 and second/feed plate 17 each further comprise the central hole 26 that is centrally intersected by the central height axis C. The guide holes 25 and central holes 26 run fully through the plate height (defined by the edge surface) and have opposing top and bottom surface openings. Each guide plate's edge surface follows a generally arcing contour, such that each pair of guide holes 25 is orthogonally offset relative to the central height axis C.

Referring to FIG. 4, a front perspective view shows an exploded spindle, or drill assembly 50 and an exploded ball screw feed mechanism, or thrust assembly 75 in a normal orientation relative to an operational configuration. The drill assembly 50 comprises a drive motor, or drill 55, the drill further comprising a motor housing 55a, a handle 55b, and a drilling end 55c. A drive shaft 56 rotatably mates with the drilling end 55c, the drive shaft comprising a shaft opening 56a for receiving a set screw 59a, this set screw threadably engageable within the shaft opening 56a in order to lock the position of a bushing 59 inserted into the drive shaft 56. The drive shaft 56 runs through a plurality of tapered roller bearings 58, an exemplary pair of these bearings being substantially nested within the spindle plate 16 through its central hole 26. An exemplary socket head screw 65a secures the drive shaft 56 to the drilling end 55c. A securing subassembly secures the spindle to the spindle plate 16, this subassembly comprising a pair of bearing plates 65e secured to the spindle plate 16 via securing screws 85. The securing subassembly further comprises a hex nut subassembly positioned between the drilling end 55c and the bearing plates 65e, the hex nut subassembly including thin hex nuts 65b, a standard washer 86, and an internal tooth lock washer 65c engaged in-between the thin hex nuts 65b.

The ball screw feed mechanism, or thrust assembly 75 mates with the drill 55 via the aforementioned thrust handle 80. Nested within the thrust handle 80 are a thrust bearing 81 and a standard washer 86, these nested elements secured by a cover plate 82 and securing screws 85. The lead screw 77 runs through the thrust handle 80 and associated/nested components, the lead screw 77 further running through the central plate nut 78 and mating at one end with the hand feed wheel 76 via a standard washer 86 and securing screw 85.

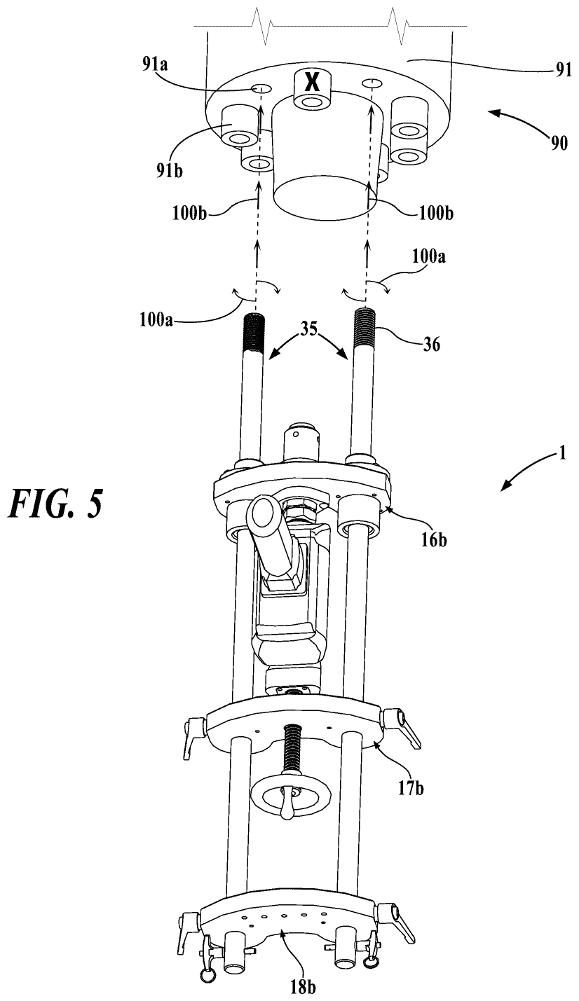

Referring to FIG. 5, a back perspective view shows an adaptive drilling device 1 in a normal position relative to an operational configuration and being installed onto a simplified CRD mechanism 90 at its lower end. The lower part of the CRDM 90 includes a main seal flange 91 secured via main flange bolts 91b running through bolt holes 91a. An affected or targeted flange bolt 91b is marked with an “X”. The CRDM bolts 91b each have a length which is securable into the bolt hole 91a having a similar length, a series of bolt holes 91a arranged circularly. The adaptive drilling device 1 can be oriented into a normal position in which both the drill bit 60 and an extractable CRDM bolt “X” are lengthwise axially aligned with the central height axis C while each guide rod 35 and a corresponding CRDM bolt hole 91a are lengthwise axially aligned with a respective guide hole axis G1/G2. Each of the corresponding CRDM bolt holes 91a are positioned adjacent to the extractable CRDM bolt “X”, the guide rods 35 being securable within their corresponding CRDM bolt holes 91a to establish an operational configuration for the adaptive drilling device. Exemplary guide rods 35 are securable within their corresponding CRDM bolt holes 91a via their threaded ends 36. Linear motion arrows 100b indicate the direction and path of installation for the guide rods 35 toward and into the bolt holes 91a. Rotational motion arrows 100a indicate the twisting of each guide rod into securement within the bolt holes 91a to establish an operational configuration for the adaptive drilling device 1. The spindle plate 16, with bottom surface 16b, can be linearly adjusted or driven via the feed plate 17 and hand feed wheel 76. The bottom surface 17b of the feed plate 17 and the bottom surface 18b of the stabilizer plate 18 are highlighted in this view.

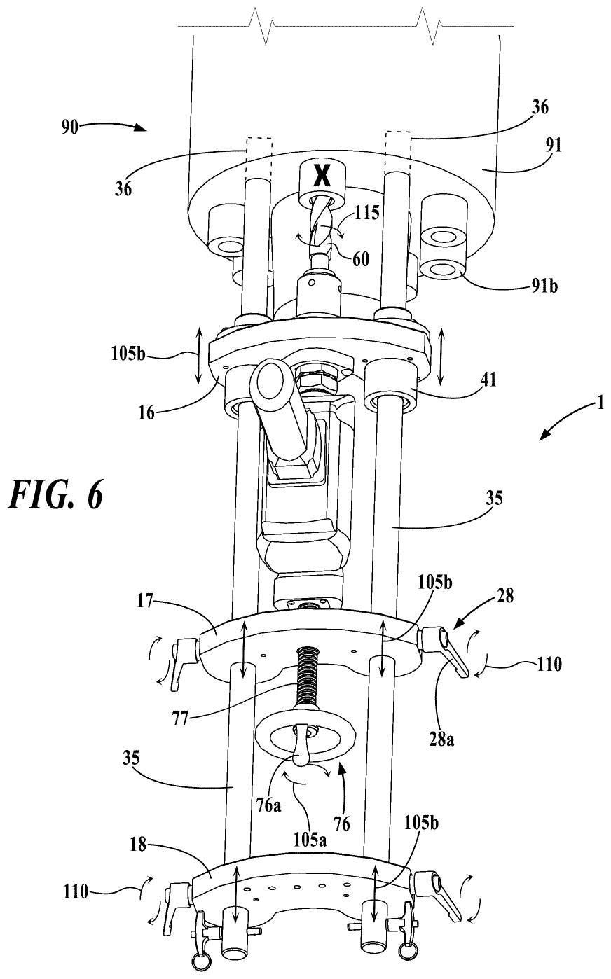

Referring to FIG. 6, a back perspective view shows an adaptive drilling device 1 installed onto the main seal flange 91 of a simplified CRD mechanism 90 and in an operational configuration wherein the drill bit 60 is inserted through the affected CRDM bolt 91b, or bolt “X”. Drilling activity, or bit rotation, within the affected bolt “X” is indicated by rotational motion arrow 115. The threaded ends 36 of the guide rods 35 are positioned inside of the CRDM bolt holes 91a and thus are hidden and shown with dashed lines. The feed plate 17 and stabilizer plate 18 can be locked and unlocked by manipulating or rotating the rotatable handles 28a of the sliding locks 28, engaging or disengaging the locks, as indicated by rotational motion arrows 110. Linear motion arrows 105b indicate guide plate and spindle adjustment along the guide rods 35, this adjustment and motion facilitated by linear bearings 41 attached to the spindle plate 16. The knob 76a of the hand feed wheel 76 can be manipulated to cause rotation of the wheel 76, as indicated by rotational motion arrow 105a. Feed wheel rotation 105a is translated into linear movement of the lead screw 77 along the central height axis C, causing the same movement for the drill assembly 50 and spindle plate 16.

Referring to FIG. 7, a back perspective view shows an adaptive drilling device 1 augmented by accessories including a barrel attachment 97, a support bar assembly 98, and a foot control pedal 96. In an exemplary embodiment, the drive motor 55 is in electrical communication with and operable by the foot control pedal 96, the foot control pedal providing variable speed control for the drive motor. The foot control pedal 96 comprises a pivot point 96a upon which the pedal can pivot in order to vary the control speed, this action indicated by pivoting motion arrows 120. The foot control pedal 96 maintains electrical communication with the drive motor 55 through a series of cords 55d. The exemplary barrel attachment 97 is one of a plurality of possible job-specific attachments that may be combined with the adaptive drilling device 1 in order to adapt to varying drilling situations that present varying and unique structures with which the drilling device can mate. The barrel attachment 97 comprises an anchoring loop 97a with loop lock 97aa, as well as a device interface 97b which accepts the linear guides 35 and drill bit 60 through a series of openings having an arrangement pattern matching that of the guides 35 and bit 60. The threaded holes 18e of the stabilizer plate 18 can receive a support bar assembly 98 comprising a plate anchor 98a, a support bar 98b, and an adjustment knob 98c. The knob 98c is centrally attached to the plate anchor 98a which is secured to the stabilizer plate 18 via securing screws. The support bar 98b runs fully through the width of the plate anchor 98a. The support bar assembly can provide triangulation to white iron if necessary.

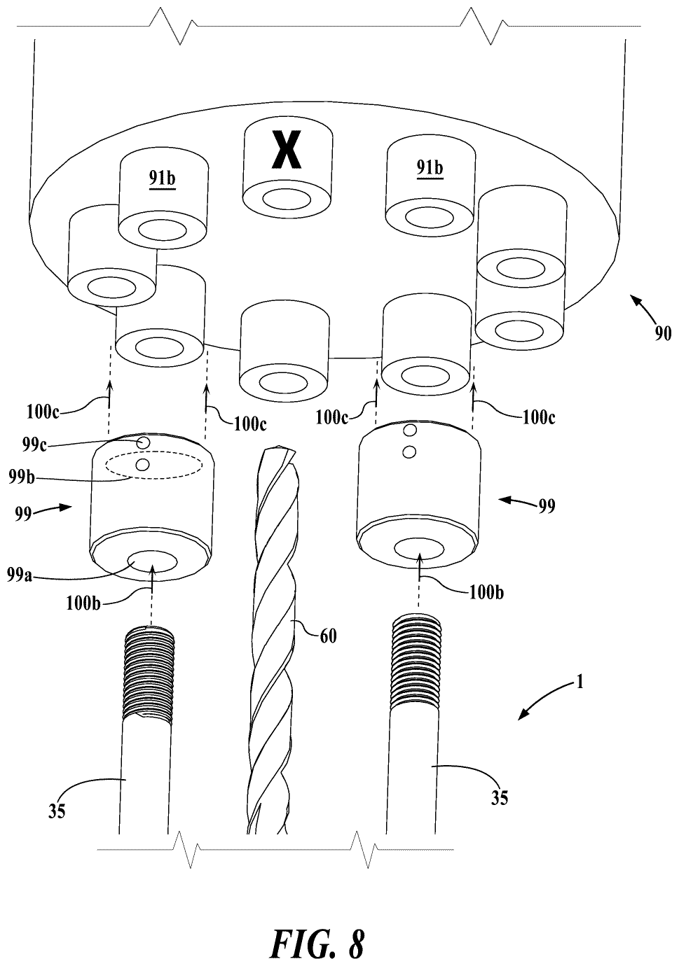

Referring to FIG. 8, a perspective view shows an adaptive drilling device 1 in a normal position relative to an operational configuration and being installed onto a simplified CRD mechanism 90 using adapter nuts 99, in order to extract the affected bolt “X”. In this scenario, if the adjacent pair of main flange bolts 91b are affected or damaged as well, such that they cannot be removed and replaced with the guide rods 35, an alternative operational configuration can be established for the adaptive drilling device 1 by securing the guide rods 35 directly to the heads of the CRDM bolts 91b via adapter nuts 99. Each adapter nut 99 comprises a small threaded opening 99a, a large opening 99b, and lateral holes 99c. The threaded end 36 of a guide rod 35 is receivable within the small threaded opening 99a, securing the guide rod 35 within the adapter nut 99. Linear motion arrows 100b indicate this installation of the guide rods 35 into the small threaded openings 99a of the adapter nuts 99. The head of a bolt 91b is receivable within the large opening 99b (shown here in dashed lines, as it is not visible in this view and lies on a side opposing that side having the small opening 99a), securing the adapter nut 99 on the head of the bolt 91b. Linear motion arrows 100c indicate this installation of the adapter nuts 99 onto the heads of the bolts 91b. Using just one adapter nut 99 is recommended, using two for both adjacent bolts 91b may require extra precautions to be taken during device installation and drilling activities. The adaptive drilling device 1 can otherwise be utilized normally in this alternative operational configuration, such that the drill bit 60 can be utilized to drill and extract the affected bolt “X”.

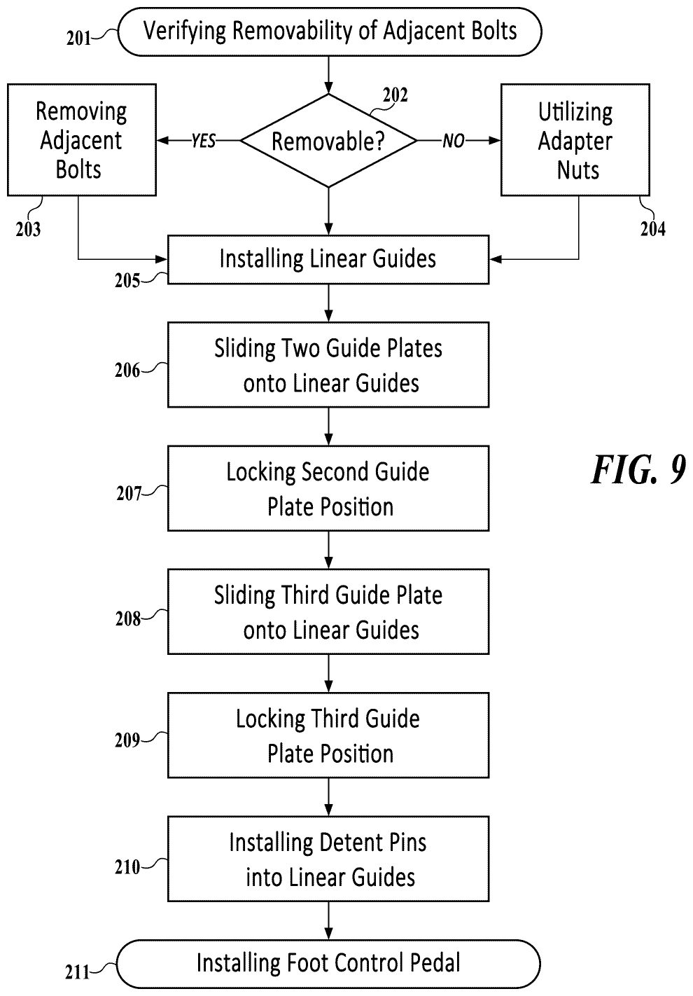

Referring to FIG. 9, a flowchart outlines a series of steps taken in order to install an adaptive drilling device 1 into an operational configuration. The adaptive drilling device 1 is designed as a purpose-built portable platform for drilling out seized bolting on control rod drive mechanisms found in Boiling Water Nuclear Reactors. An exemplary embodiment fits a GE/Hitachi CRD commonly found in plants of this nature. Depending on the condition of the bolting, multiple functions are available to a user of the device 1, such as drilling, extraction, tap drilling, guided chasing of threads, and (worst case scenario) drilling and tapping for possible engineered thread repair insert. The adaptive drilling device 1 is designed for easy set up, offering a precise means to make repairs while saving time/dose (in radiation), and money, while enhancing safety and control over the repair in an otherwise very challenging location. This design also allows the device 1 to adapt to other applications as necessary via different job specific attachments, including those that facilitate barrel or tank drilling options. A solid knowledge of field machining experience is highly recommended for a user of the device 1. Use of the device 1, though simple enough, does require a methodical, prudent approach to a process that includes chip removal and heat dissipation. The process should be carried out carefully and slowly.

Beginning the method, step 201 includes an assessment of the removability of two main flange bolts on both sides of the affected bolt. Step 202 continues this assessment with a decision on the assessment, if “yes”, the bolts are removable and a user can do so, as indicated by step 203. Following this decision, step 205 includes threading one linear guide 35 into either one of the vacant bolt holes 91a and snugging hand tight. A user can thread the other linear guide 35 into the other vacant hole 91a until it just starts to snug, yet is still somewhat floating.

If in the above assessment of step 202, the bolts 91b are not removable, it may become necessary to use a set of supplied adapter nuts 99, that is if one or more adjacent bolts are nonremovable. The adapter nuts 99 enable the linear guides 35 to still be attached to the head of the existing cap screws of the flange bolts 91b, as indicated by step 204. Step 205 may then follow step 204 normally. It is always preferable to use existing bolt holes 91a or only one adapter nut 99 for safety reasons, except in extreme cases of multiple stuck bolts. Extreme usage scenarios are regarded as a contingency measure, to only be carried out when other options are not available. The offset of the guide rods 35 when using the one hole 91a and one adapter nut 99 configuration will not affect proper functioning of the adaptive drilling device 1. A safety strap or some sort of restraining device should be employed to prevent the device 1 from freefalling should it become unattached. Drilled and tapped holes are placed in the stabilizer plate to provide a secondary anchor point for convenience.

Step 206 includes sliding the top spindle plate 16 and feed plate 17 onto the guide rods 35 as a unit. The guide plates should be placed into a comfortable position mid-way up the guide rods 35. The sliding locks 28 should then be set on the feed plate 17 firmly, as indicated by step 207. The stabilizer plate 18 should be slid on about two inches above the cross-drilled pin pass-through holes 37 in the guide rods 35, as indicated by step 208. The locks 28 should be set on the stabilizer plate 18 firmly, as indicated by step 209.

While keeping one hand on the feed plate 17 for safety, a user should insert the detent pin 40 into the pin pass-through 37 in the first rod 35 that was hand tightened, as indicated by step 210. The detent pins 40 provide a safety stop if all locks 28 were accidently released and the frame/guide assembly was allowed to freefall downward. It is very important to keep a hand or a lock 28 engaged on the guide assembly to prevent gravity from creating a condition that could possibly injure the user/operator, or damage the adaptive drilling device 1. Most of such conditions are the result of operator error. Once both locks 28 on the first guide rod 35 are secure and safety detent pins 40 are in place, the user can release the locks on the second guide rod 35 and snug hand tight. With the use of a steel rod, the cross-drilled pin passthroughs 37 can be used to sufficiently tighten the guide rods 35. The stabilizer plate 18 can now be re-locked. Holes in the stabilizer plate 18 provide an anchor point for a piece of steel strap in case triangulation/bracing to white iron is desired.

At this point, an operator may want to install a supplied foot control pedal 96, as indicated by step 211. Doing so requires the finger switch on the drill 55 to be depressed by a hook and loop binder strap into a full “on” position. Should a drill bit 60 or cutting tool hang up, the foot pedal 96 provides a quick and easy way of shutting the adaptive drilling device 1 off and providing an extra level of control during cutting, allowing the operator to concentrate on feed control for the spindle plate 16 and spindle assembly 50 via the hand feed wheel 76.

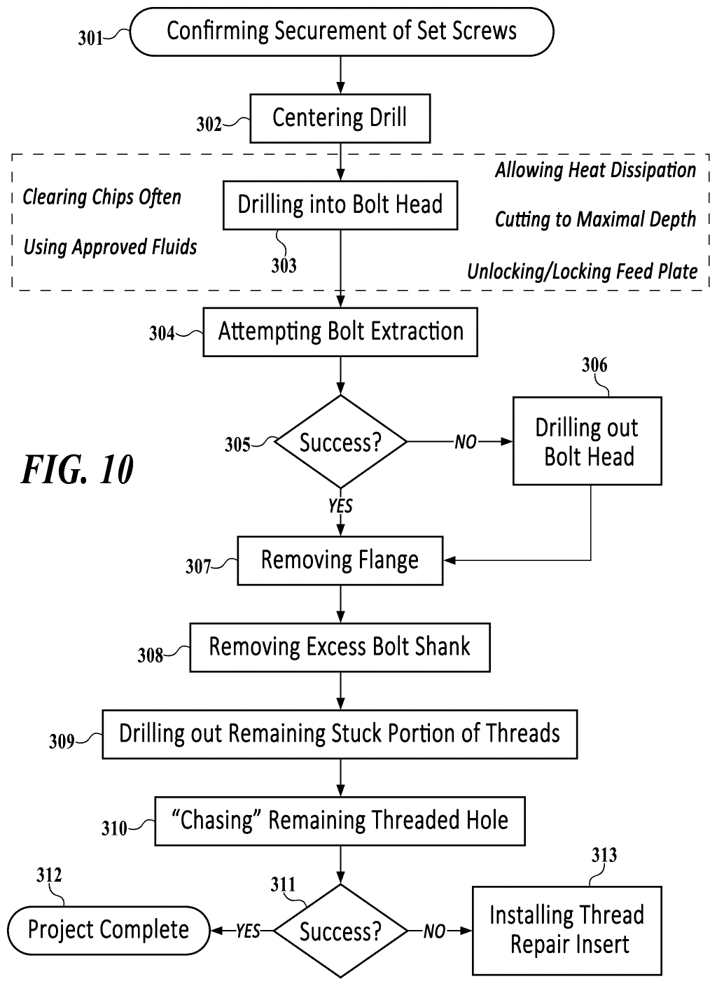

Referring to FIG. 10, a flowchart outlines a series of steps taken in order to perform drilling procedures using an adaptive drilling device 1 installed in an operational configuration. A drilling and thread recovery process includes removing a seized bolt 91b. This requires a sequentially organized approach in order to maintain the center of an existing bolt pattern. Heat and chip removal are details that require attention. A good quality, approved cutting fluid such as Anchor Lube or LPS Natural should be employed. Use of regular oil is not recommended. An operator should check with nuclear plant requirements for approved cutting fluids. Bushings are provided for standard shank drills and cutters. All set screws should be securely fastened before machining begins, as indicated by step 301. Step 302 includes centering the drill 55 to as large as possible, approximately 0.500 Dia. is preferred. Other details include a 0.500 center cutting screw machine stubby, with a plan to cut/drill as deep as possible in approximately 0.250 inch increments.

Step 303 indicates drilling into the head of the bolt 91b. While drilling, an operator or assistant should clear chips and allow heat to subside often, with a goal of cutting to a maximal depth. A chosen approved cutting fluid should be chosen as needed. Quick retraction and setting of the spindle 50 and drill 55 can be achieved by unlocking or locking the drive/feed plate 17 to facilitate power frame/guide assembly movement while the feed/lead screw 77 is traveling linearly. While drilling, the operator should feed at a rate that produces an ample chip, but not so slow that it rubs.

It is crucial to control heat and cutting action, as the bolts 91b can work-harden. Excellent quality cobalt drills are recommended. The operator should not settle for cheap drills. If the drill 55 or bit 60 is not cutting well, it should be promptly replaced. A 0.500 Dia. Jobber Length drill, a 0.625 Dia. Jobber Length drill, and a 0.625 Dia. Extended Length drill can be utilized in the same method as outlined above. A 0.500 Dia. Extended Length drill may also be utilized in the same manner as discussed above, until through the bolt 91b, feeding lightly as the bit 60 breaks through.

At this point, while the head of the bolt 91b is still intact, removal of the bolt should be attempted, as indicated by step 304. It is highly likely that the internal stresses have been relieved from the bolt, such that it may unscrew without further work, this successful result indicated by “yes” at step 305.

If extraction is not achieved, as indicated by “no” at step 305, the head of the bolt 91b can be drilled out to 0.875. About 1″ to 1.250″ in, the head of the bolt 91b will detach from the remaining body of the bolt, as indicated by step 306. Removal of the flange and the attached mechanism will now be possible, as indicated by step 307.

After Flange removal, any excess bolt shank should be removed flush, as indicated by step 308. This will leave only the remaining stuck portion of the screw threads that can be drilled to 0.875 (tap drill Dia. for 1.00″×8 thread), as indicated by step 309.

A 1″-8″ pitch taper tap can then be used with a tap handle as a driver to “chase” the remaining threaded hole, as indicated by step 310. Care should be exercised to gently allow the tap to follow the pre-existing thread, dead center. If there is a positive result in step 310, as indicated by “yes” at step 311, the current project is complete, as indicated by step 312. The tap handle is provided as a guide to ensure the tap is supported and remains straight and on location. Power tapping is not an option and should not be attempted.

The adaptive drilling device 1 is provided with an array of standard size bushings that will accommodate most any drill or annular-type cutter that may be used to prepare the bolt hole 91a for further repair. In the case of a catastrophically damaged thread, an operator should refer to Nuclear Plant Engineering for possible thread repair insert options and preparation, as indicated by step 313. As always, safety should be the number one priority, and the adaptive drilling device 1 should be “doing all of the work”.

In an exemplary embodiment, the drill motor 55 and controls of the adaptive drilling device 1 are made from easily sourced, inexpensive hardware that can be easily replaced if contaminated. The remainder of the components are custom-machined and fabricated in a manner to allow for decontamination.

Testing a full-size mock-up of a BWR's under-vessel, the following design criteria were established for addressing certain needs arising during usage of the adaptive drilling device 1:
1) A dedicated, job-specific inverted drilling platform that is safe and easy to set up and operate in adverse conditions.
2) The ability to fit into the narrow area separating CRDs and instrumentation, while using the existing CRDM bolt pattern for mounting & precise location of the drilling device 1.
3) Reducing setup time, increasing accuracy and control, and further supporting reconditioning of the threaded hole. Maintaining the bolt hole location with the least complicated machine setup possible.
4) Having the ability to operate with heavy gloves, using minimal effort, and with minimal risk of cutting the gloves.
5) Acting as a tap guide in order to safely chase the existing thread.
6) Being robust and torque-responsive enough to support drilling and tapping for a threaded insert if the need arises.
7) Operating in a generally smooth and rigid manner.
8) Generally being efficient.
9) Being made with locally sourced components as much as possible.
10) Using similar profile custom machined 6061 aluminum main body sections, brass locking lugs, and a steel spindle, offset coupler/thrust handle, and drill sleeves.
11) Utilizing linear slides or linear bearings with the guide rods. Further yet, utilizing a handwheel-driven ball screw feed.
12) Providing a robust yet inexpensive gear reduction drill motor that can easily be replaced in case of contamination.
13) Maximizing cost effectiveness and time savings, since time equals money and dose.
14) Being adaptive to other job-specific applications if the need arises.
15) Generally being proven, refined, user friendly, and suitable for sale on a commercial basis.

Additionally, the above mock-up test yielded the following results:
1) Time from inception to mock-up trial and successful run: 6 days (5 days working).
2) Days until the drilling device is finalized, with the addition of a foot control pedal and variable speed control: 7 Days. A contractor assigned operator duties on the mock-up, with the drilling device inventor overseeing operation.
3) From hardcase to resulting CRDM bolt with 0.625 hole drilled through 5.500″ length, dead center, and back in the hardcase: less than 1.5 hours. At this point, a 1 inch, 8 TPI alloy bolt would most likely relieve enough stress to enable intact bolt removal, adding 1-3 hrs. to tap the drill hole and re-tap.

By way of an exemplary scenario, if a CRDM in question was bolted back up, it could be addressed with the adaptive drilling device 1 at the nuclear facility's next refuel outage. In the short term, this offers a reliable contingency plan in the event that the CRDM in question, or any other CRDM in a set, presents a problem during the next hydrodynamic testing of the pressure vessel prior to startup. If the hydrodynamic testing does not go well going into startup, then the adaptive drilling device 1 can be used to effectively address the problem. As such, the adaptive drilling device 1 can provide a safety net or solution in the event of CRDM leakage during the testing. Otherwise, moving forward with the testing would be risky due to potential CRDM leakage.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. An adaptive drilling device for extracting bolts from a control rod drive mechanism (CRDM) in a boiling water nuclear reactor, the adaptive drilling device having a central height axis and comprising:
(a.) a guide assembly configured to align and secure drilling activity, the guide assembly comprising:
(i.) three guide plates, the guide plates including a first, second, and third plate positioned along the central height axis, each guide plate having a top surface and an opposing bottom surface, as well as an edge surface, each guide plate further comprising a pair of guide holes disposed symmetrically relative to the central height axis, a first set of three guide holes being axially aligned along a first guide hole axis, a second set of three guide holes being axially aligned along a second guide hole axis, both guide hole axes running parallel to the central height axis;
(ii.) a pair of guide rods having lengths and diameters, the guide rods being parallel to each other while running centrally through the guide holes along said rod lengths, a first guide rod running through the first set, a second guide rod running through the second set, the guide plates being slidably engaged with the guide rods rods, the second and third guide plates each configured to have a lockable position along the guide rods;
(b.) a drill assembly configured to drive a drill bit into a CRDM bolt, the drill assembly comprising:
(i.) a gear reduction drive motor;
(ii.) drill bearings;
(iii.) a drill bit having a length, the drill bit rotatably driven by the drive motor, the drill bit being axially aligned with the central height axis along said bit length;
(iv.) a securing subassembly configured to secure the drill assembly to the first guide plate;
(c.) a thrust assembly configured to linearly and bidirectionally drive the drill assembly, the thrust assembly comprising:
(i.) a thrust handle connected to the drive motor;
(ii.) a central plate nut;
(iii.) a lead screw running through the central plate nut and connected to the thrust handle;
(iv.) a feed wheel connected to the lead screw, the feed wheel configured to rotatably provide thrust driving the first guide plate and drill assembly along the central height axis; and,
wherein the CRDM bolts each have a length which is securable into a bolt hole having a similar length, a series of bolt holes arranged circularly, wherein the adaptive drilling device can be oriented into a normal position in which both the drill bit and an extractable CRDM bolt are lengthwise axially aligned with the central height axis while each guide rod and a corresponding CRDM bolt hole are lengthwise axially aligned with a respective guide hole axis, each of said corresponding CRDM bolt holes positioned adjacent to the extractable CRDM bolt, the guide rods being securable within said corresponding CRDM bolt holes to establish an operational configuration for the adaptive drilling device.

2. The adaptive drilling device of claim 1, wherein each guide plate's top and bottom surfaces run parallel to each other and orthogonally to the central height axis, the edge surface running continuously between the top and bottom surfaces and orthogonally relative to said surfaces, each edge surface defining the height of the plate, the first and second guide plates each further comprising a central hole that is centrally intersected by the central height axis, the guide holes and central holes running fully through the plate height and having opposing top and bottom surface openings.

3. The adaptive drilling device of claim 2, wherein the gear reduction drive motor is positioned between the first and second guide plates, wherein the drill bit runs centrally through the first guide plate's central hole and projects away from the first guide plate's top surface, wherein the thrust handle is positioned between the first and second guide plates, the thrust handle further comprising a thrust bearing, wherein the central plate nut is nested within the second guide plate's central hole, wherein the lead screw runs through the thrust bearing, the lead screw projecting past both the top and bottom surfaces of the second guide plate, and wherein the feed wheel is positioned between the second and third guide plates.

4. The adaptive drilling device of claim 3, wherein the second and third guide plates each further comprise a pair of edge holes in the edge surface, each pair of edge holes disposed symmetrically relative to the central height axis, each edge hole configured to slidably receive a lock, each pair of sliding locks configured to lock and unlock the respective plate's position along the guide rods, wherein each guide rod comprises a threaded end, these threaded ends projecting away from the first guide plate's top surface, the guide rods being securable within the corresponding CRDM bolt holes via these threaded ends, and wherein each guide rod further comprises a pass-through hole on that end of the guide rod opposing the threaded end, each pass-through hole running fully through the diameter of the rod and configured to slidably receive a detent pin, the received detent pins providing a stop to prevent the sliding of guide plates and associated assemblies beyond the length of the guide rods.

5. The adaptive drilling device of claim 4, wherein the drive motor is in electrical communication with and operable by a foot control pedal, the foot control pedal providing variable speed control for the drive motor, and wherein the adaptive drilling device is configured to be augmentable with job-specific attachments, including a barrel attachment.

6. The adaptive drilling device of claim 5, wherein each guide plate's edge surface follows a generally arcing contour, such that each pair of guide holes is orthogonally offset relative to the central height axis.

7. The adaptive drilling device of claim 6, wherein the second and third guide plates each further comprise another pair of holes running fully through the plate height, these holes being smaller in size than the guide holes and each configured to receive a roll pin, each guide hole of the second and third guide plates further having a curved inner contact opening within the hole and orthogonally positioned relative to the hole's top and bottom surface openings, wherein each sliding lock further comprises a rotatable handle and a shaft, the shaft comprising both a rod notch and a pin notch, the shaft being the slidable portion received by the guide plate's edge hole, each edge hole positioned with a proximate guide hole and rod, as well as a proximate roll pin receiving hole, and wherein rotation of the sliding lock handles provides the locked or unlocked plate positions, each rod notch slidably contacting its proximate guide rod through the curved inner contact opening in the unlocked plate configuration, each pin notch slidably contacting its proximate roll pin in the unlocked plate configuration, the rod and pin notches losing said slidable contact in the locked plate configuration.

8. The adaptive drilling device of claim 6, wherein the first guide plate has attached linear bearings configured to facilitate linear plate motion along the guide rods, wherein the drill bearings are tapered roller bearings, the securing subassembly further comprising a pair of bearing plates secured to the first guide plate, wherein the second guide plate's edge surface includes a central edge hole running orthogonally to the central height axis, the central plate nut being secured by a set screw received in the central edge hole, wherein the central plate nut and lead screw both have an Acme thread form, and wherein each detent pin further comprises a T-handle with a ring, and a pin portion with a ball detent, the pin portion being received by the pass-through hole.

9. The adaptive drilling device of claim 4, wherein an alternative operational configuration can be established for the adaptive drilling device by securing the guide rods directly to the CRDM bolts via adapter nuts, and wherein the third guide plate is configured to receive a support bar assembly, the support bar assembly configured to provide triangulation to white iron.

10. An adaptive drilling device comprising:
(a.) a guide assembly configured to align and secure drilling activity, the guide assembly comprising:
(i.) guide plates, including a spindle plate, a locking feed plate, and a locking stabilizer plate;
(ii.) securable linear guides running in parallel through the guide plates, the guide plates being slidably engaged with the linear guides;
(b.) a spindle assembly configured to drive a drill bit, the spindle assembly secured to the spindle plate with a securing subassembly, the spindle assembly comprising a drive motor and a spindle mechanism, the spindle mechanism integrated with the spindle plate;
(c.) a ball screw feed mechanism configured to linearly and bidirectionally drive the spindle plate and spindle assembly;
(d.) two pairs of plate locks, one pair integrated with the feed plate and one pair integrated with the stabilizer plate, the plate locks configured to lock and unlock the respective plate's position along the linear guides;
(e.) a pair of detent pins that are slidably receivable by the linear guides, one detent pin received per linear guide, the received detent pins configured to provide a stop to prevent the sliding of guide plates and associated assemblies and mechanisms beyond the linear guides;
(f.) a foot control pedal configured to operate the drive motor, the foot control pedal further configured to provide variable speed control for the drive motor; and,
wherein the positions of the spindle mechanism and linear guides form an arrangement pattern, and wherein the adaptive drilling device is configured to adaptively integrate with a plurality of bolted structures via said arrangement pattern in order to facilitate drilling activity.

11. The adaptive drilling device of claim 10, wherein the spindle plate has attached linear bearings configured to facilitate linear plate motion along the guide rods.

12. The adaptive drilling device of claim 11, wherein the drive motor includes gear reduction functionality, the drive motor positioned between the spindle plate and the feed plate.

13. The adaptive drilling device of claim 12, wherein each plate lock comprises a rotatable handle configured to provide the locked or unlocked plate positions, wherein each detent pin comprises a T-handle with a ring, and a pin portion with a ball detent, the pin portion being received by the linear guide, wherein the adaptive drilling device is configured to be augmentable with job-specific attachments, including a barrel attachment, and wherein the stabilizer plate is configured to receive a support bar assembly, the support bar assembly configured to provide triangulation to white iron.

14. The adaptive drilling device of claim 13, wherein each guide plate has a generally arcing contour, wherein the arrangement pattern of the spindle mechanism and linear guides matches that of control rod drive mechanism (CRDM) bolts and associated bolt holes, the linear guides being securable within the CRDM bolt holes to establish an operational configuration for the adaptive drilling device whereby drilling activity is facilitated, wherein the drilling activity includes CRDM bolt extraction, and wherein an alternative operational configuration can be established for the adaptive drilling device by securing the linear guides directly to the CRDM bolts via adapter nuts.

15. A method for installing an adaptive drilling device onto a bolted structure to provide an operational configuration of the device, the method comprising:
(a.) Identifying a seized bolt and verifying the removability of two bolts adjacent to said seized bolt, the two adjacent bolts having heads;
(b.) If the adjacent bolts are removable, then removing them to reveal bolt holes;
(c.) If one or both adjacent bolts are nonremovable, then installing an adapter nut onto the head of any of said nonremovable bolts;
(d.) Installing linear guides into the bolt holes or adapter nuts;
(e.) Sliding a first guide plate then a second guide plate onto the linear guides;
(f.) Locking the position of the second guide plate;
(g.) Sliding a third guide plate onto the linear guides;
(h.) Locking the position of the third guide plate;
(i.) Installing detent pins into the linear guides; and,
(j.) Installing a foot control pedal.

16. The method of claim 15, wherein the adaptive drilling device comprises a spindle assembly configured to drive a drill bit, the drill bit and linear guides forming an arrangement pattern, and wherein the operational configuration can be utilized for activities including drilling, extraction, tap drilling, guided chasing of threads, and drilling and tapping for engineered thread repair insert.

17. The method of claim 16, wherein the adaptive drilling device is configured to be augmentable with job-specific attachments, including a barrel attachment.

18. The method of claim 17, wherein the linear guides include cross-drilled holes for receiving the detent pins, or for further receiving steel rods, the inserted steel rods configured to substantially tighten the linear guides.

19. The method of claim 18, wherein the third guide plate is configured to receive a support bar assembly, the support bar assembly configured to provide triangulation to white iron.

20. The method of claim 19, wherein the adaptive drilling device is installed onto a control rod drive mechanism (CRDM) in a boiling water nuclear reactor.
